(19) United States
(12) Patent Application Publication
(10) Pub. No.: US 2020/0399468 A1
(43) Pub. Date: Dec. 24, 2020

(54) POLYAMIDE COMPOSITION FOR LIQUID-ASSISTED INJECTION MOULDING APPLICATIONS

(71) Applicant: BASF SE, Ludwigshafen (DE)

(72) Inventor: Huanbing WANG, Shanghai (CN)

(21) Appl. No.: 16/969,433

(22) PCT Filed: Feb. 13, 2019
(86) PCT No.: PCT/EP2019/053551

§ 371 Date: Aug. 12, 2020

(30) Foreign Application Priority Data
Feb. 14, 2018 (CN) PCT/CN2018/076857

(51) Int. Cl. C08L 77/06; C08L 77/02; C08K 7/14; C08K 7/06; C08K 7/10; C08K 7/20; C08K 5/00; C08K 3/40; B29C 45/17; C08G 69/06

(52) U.S. Cl. CPC C08L 77/06; C08L 2205/035; C08K 7/14; C08K 7/06; C08K 7/10; C08K 7/20; C08K 5/005; C08K 5/0066; C08K 3/40; B29C 45/1704; C08G 69/06; C08L 2203/18; C08L 2203/30; C08L 2205/02; C08L 77/02

(57) ABSTRACT

The disclosure relates to a polyamide composition including (i) at least one aliphatic polyamide comprising repeating units derived from the polycondensation of hexamethylenediamine and adipic acid; (ii) at least one semi-aromatic polyamide comprising repeating units derived from the polycondensation of hexamethylenediamine, adipic acid and at least one aromatic dicarboxylic acid; (iii) at least one fibrous filler; (iv) at least one particulate filler; (v) at least one heat stabilizer; and (vi) at least one further additive. The polyamide composition exhibits excellent processing properties in the preparation of articles using liquid-assisted injection moulding processes.

The invention relates to a polyamide composition which exhibits excellent processing properties in the preparation of articles using liquid-assisted injection moulding processes. More particular, when using the polyamide composition of the invention in liquid-assisted injection moulding processes, articles, in particular hollow articles such as tubes, pipes, conduits, having excellent surface properties and improved resistance against chemicals, in particular alcohols such as glycols are obtainable. The articles may be used in particular be used for liquid storage and liquid transportation applications, for example in automotive applications.

### PRIOR ART

Glass fibre filled polyamide products are widely used as structural components and fluid storage parts or fluid transportation parts. Such parts typically have hollow shapes. When using polymer melts comprising glass fibres during the processing of polymer compositions, e.g. during injection moulding processes, the glass fibres tend to float onto the surface and thus resulting in an uneven, unattractive surface. However, the roughness of the article surface is not only an aesthetic disadvantage, but also deteriorates the function of the article, in particular in fluid storage or fluid transportation applications.

Parts used in automotive applications, like tanks, ducts for fuel, air or coolant in combustion engines are hollow bodies which must mechanically withstand external aggression but also require an inner face which is as smooth as possible to avoid disturbing the flow of fluids therein. In addition, such articles have complex shapes to allow their assembly in the engine.

EP 1 136 221 A1 discloses a method for manufacturing a hollow body by injecting a liquid composition into a mould. The composition includes a thermoplastic polymer and reinforcing fibres with a length/diameter ratio≥20 and particles with a length/diameter ratio≤20. The injection liquid may be water and the composition includes a nucleating agent. The thermoplastic may be 10-60 wt.-% of the whole composition. In one embodiment, the thermoplastic matrix comprises at least one polyamide. The manufacturing method uses liquid-assisted injection moulding technology, a refinement of gas injection moulding technology. It is a high efficient method to form tubular articles like fluid transportation systems, for automotive applications.

Liquid-assisted injection moulding was described for example in Kunststoffe, vol. 88, no. 1, 1998, pages 34-36. Briefly, a certain amount of material sufficient to completely fill the mould is injected into a mould of corresponding shape to that of the part to be moulded. Then, a needle to allow the supply of a liquid, preferably water, under pressure is introduced into the mass thus injected at one or more points. The liquid generates a cavity in the melt injected by forcing the polymer to conform to the mould walls. After cooling, the part is demoulded. In an alternative embodiment, the mould is completely filled with the thermoplastic composition, the pressurized liquid is injected into said body for discharging a portion of the material out of the mould and thereby forming a cavity while maintaining a portion of the material against the walls of the mould until solidification.

However, to prepare articles that will allow circulating fluids without disturbance, it is necessary to obtain a particular smooth inner surface as well as uniform wall thickness. In addition, for reasons of productivity, it is also required that the moulding cycle time is as fast as possible.

These requirements are currently difficult to obtain simultaneously limiting the use of this technique for the manufacture of certain items, including conduits for fuel, coolant combustion engines or internal combustion. As the processing is more complicated than for normal injection moulding, the technique faces more challenges to form a smooth, high gloss surface. Common additives to improve gloss often deteriorate the glycol resistance. It is important to find a solution to balance the mechanical properties, surface quality and glycol resistance performance.

An object of the present invention is to remedy these drawbacks by proposing a fibre filled thermoplastic material, which is appropriate to be used in injection moulding processes, in particular in liquid-assisted injection moulding processes and which combines particular characteristics that allow to obtain articles having the characteristics of surface condition, shape uniformity and improved cycle time and satisfactory for an industrial manufacturing.

### INVENTION

The present invention relates to a polyamide composition, comprising

(i) at least one aliphatic polyamide comprising repeating units derived from the polycondensation of hexamethylenediamine and adipic acid;

(ii) at least one semi-aromatic polyamide comprising repeating units derived from the polycondensation of hexamethylenediamine, adipic acid and at least one aromatic dicarboxylic acid;

(iii) at least one fibrous filler;

(iv) at least one particulate filler;

(v) at least one heat stabilizer;

(vi) at least one further additive;

(vii) optionally at least one polyamide selected from homopolymers of ϵ-caprolactam (PA6), copolymers of ϵ-caprolactam with hexamethylenediamine and terephthalic acid and copolymers of ϵ-caprolactam with hexamethylenediamine and isophthalic acid; and

(viii) optionally at least one polyamide selected from homopolymers of hexamethylenediamine and sebacic acid (PA6.10).

It was surprisingly found by the inventors that by introducing at least one semi-aromatic polyamide as defined above in a polyamide composition, comprising the at least one aliphatic polyamide and the recited fillers, an improved polyamide composition is obtained which may be used for the production of articles having significantly improved surface properties with respect to smoothness and gloss whereas resistance against chemicals such as alcohols, in particular glycols, is not significantly deteriorated.

The components of the polyamide composition according to the invention are described in more detail in the following.

The inventive polyamide composition comprises at least one aliphatic polyamide comprising repeating units derived from the polycondensation of hexamethylenediamine and adipic acid. The at least one aliphatic polyamide may optionally comprise further aliphatic repeating units derived from monomers which are copolymerizable with hexamethylenediamine and adipic acid.

Preferably, the at least one aliphatic polyamide has a number average molecular weight (Mn), determined by gel permeation chromatography (GPC) of 10,000 to 30,000 g/mol, in particular 12,000 to 24,000 g/mol.

In one embodiment of the invention, the at least one aliphatic polyamide is selected from homopolymers of hexamethylenediamine and adipic acid (PA6.6), copolymers of hexamethylenediamine, adipic acid and ϵ-caprolactam (PA6.6/6) and mixtures or blends of these aliphatic polyamides. If the aliphatic polyamide is a homopolymer comprising repeating units derived from ϵ-caprolactam, these repeating units are present in an amount of 1 to 30 mol.-%, preferably 5 to 20 mol-% and in particular 7 to 15 mol-%, based on the total weight of the at least one aliphatic polyamide. The remainder of the polyamide is then preferably composed of repeating units derived from hexamethylenediamine and adipic acid in a molar ratio of 1:1.

The at least one aliphatic polyamide is present in the polyamide composition in amounts of 40 to 70 wt.-%, preferably 45.0 to 67.5 wt.-%, based on the total weight of the polyamide composition.

If the at least one aliphatic polyamide is selected from copolymers of hexamethylenediamine, adipic acid and ϵ-caprolactam (PA6.6/6), only the repeating units derived from hexamethylenediamine and adipic acid account to the amount of 40 to 70 wt.-%, preferably 45.0 to 67.5 wt.-%, of the at least one aliphatic polyamide based on the total weight of the polyamide composition.

As a second component, the polyamide composition comprises least one semi-aromatic polyamide comprising repeating units derived from the polycondensation of hexamethylenediamine, adipic acid and at least one aromatic dicarboxylic acid.

In order to be able to improve the properties of the polyamide composition, it was found to be particular advantageous, if the at least one semi-aromatic polyamide comprises repeating units derived from at least one aromatic dicarboxylic acid in an amount of at least 5 mol-%, based on the total weight of the at least one semi-aromatic polyamide. In a more preferred embodiment of the invention, the least one semi-aromatic polyamide comprises repeating units derived from at least one aromatic dicarboxylic acid in an amount of 5 to 50 mol-% and in particular 10 to 30 mol-%, based on the molar composition of the least one semi-aromatic polyamide.

Thus, in other words, the semi-aromatic polyamide comprises units repeating derived from at least one dicarboxylic acid and repeating units derived from at least one diamine in a molar ratio of 1:1, wherein the repeating units derived from at least one dicarboxylic acid comprise at least one repeating units derived from at least one aromatic dicarboxylic acid and wherein the at least one repeating unit derived from at least one aromatic dicarboxylic acid accounts for 10 to 100 mol-%, preferably 20 to 60 mol-%, of the entire repeating units derived from dicarboxylic acids.

The semi-aromatic polyamides are preferably obtained from polycondensation reactions of aliphatic diamines, aliphatic dicarboxylic acids, aromatic diamines and/or aromatic dicarboxylic acids. In a further preferred embodiment, the semi-aromatic polyamide may be obtained from the polycondensation of aliphatic diamines, aliphatic dicarboxylic acids and aromatic dicarboxylic acids.

Suitable aliphatic diamines comprise all aliphatic diamines commonly used in the preparation of polyamides. Preferred aliphatic dicarboxylic acids include dicarboxylic acids of the general formula

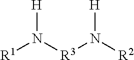

wherein

R¹ and R² each independently represent a hydrogen atom or an aliphatic, saturated or unsaturated, linear or branched hydrocarbon group having 1 to 5, preferably 1 to 3, carbon atoms; and

R³ represents an aliphatic, saturated or unsaturated, linear or branched hydrocarbon group having 1 to 20, preferably, 2 to 10, and in particular 3 to 6 carbon atoms.

In a preferred embodiment, R¹ and R² represent a hydrogen atom.

Preferred aliphatic diamines include hexamethylene diamine and/or the 5-methyl pentamethylene diamine. In a particular preferred embodiment hexamethylene diamine is used.

Suitable aliphatic dicarboxylic acids comprise all aliphatic dicarboxylic acids commonly used in the preparation of polyamides. Preferred aliphatic dicarboxylic acids include dicarboxylic acids of the general formula

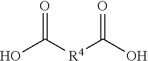

wherein

R⁴ represents an aliphatic, saturated or unsaturated, linear or branched hydrocarbon group having 1 to 20, preferably, 2 to 10, and in particular 3 to 6 carbon atoms.

In a particular preferred embodiment, adipic acid is used as aliphatic dicarboxylic acid.

In a preferred embodiment of the invention, the semi-aromatic polyamide comprises repeating units derived from aliphatic dicarboxylic acids, in particular derived from adipic acid, in amounts of from 0 mol-% to 90 mol-%, based on the total amount of repeating units derived from dicarboxylic acids, and more preferably from 40 mol-% to 80 mol-% of repeating units derived from dicarboxylic acids, whereas the remainder of the of repeating units derived from dicarboxylic acids is derived from aromatic dicarboxylic acids.

Suitable aromatic diamines comprise—if present—all aromatic diamines commonly used in the preparation of polyamides. Preferred aromatic diamines include diamines of the general formula

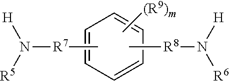

wherein

R⁵ and R⁶ each independently represent a hydrogen atom or an aliphatic, saturated or unsaturated, linear or branched hydrocarbon group having 1 to 5, preferably 1 to 3, carbon atoms;

R⁷ and R⁸ each independently represent a single bond or an aliphatic or aromatic, saturated or unsaturated, linear, branched or cyclic hydrocarbon group having 1 to 20, preferably, 2 to 10, and in particular 3 to 6 carbon atoms;

R⁹ represents a hydrogen atom or an aliphatic hydrocarbon group having 1 to 3 carbon atoms; and

n represents an integer from 0 to 4.

In a preferred embodiment, R⁷ and R⁸ each represent a single bond and the amine group is directly bonded to the aromatic ring.

In a preferred embodiment, R⁵ and R⁶ each represent a hydrogen atom.

In a further preferred embodiment, R⁹ represents a hydrogen atom.

R⁷ and R⁹ may be positions in ortho-, meta-, or para-position to each other at the aromatic ring. It is particular preferred that the groups R⁷ and R⁹ are position meta- or para-position.

Preferred aromatic diamines include m-phenylene diamine and p-phenylene diamine. In a particular preferred embodiment no aromatic diamine is used.

Suitable aromatic dicarboxylic acids comprise all aromatic dicarboxylic acids commonly used in the preparation of polyamides. Preferred aromatic dicarboxylic acids include dicarboxylic acids of the general formula

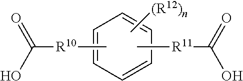

wherein

R¹⁰ and R¹¹ each independently represent a single bond or an aliphatic or aromatic, saturated or unsaturated, linear, branched or cyclic hydrocarbon group having 1 to 20, preferably, 2 to 10, and in particular 3 to 6 carbon atoms;

R¹² represents a hydrogen atom or an aliphatic hydrocarbon group having 1 to 3 carbon atoms; and

n represents an integer from 0 to 4.

In a preferred embodiment, R¹⁰ and R¹¹ each represent a single bond and the carboxylic group is directly bonded to the aromatic ring.

In a further preferred embodiment R¹² represents a hydrogen atom.

R¹⁰ and R¹¹ may be positions in ortho-, meta-, or para-position to each other at the aromatic ring. It is particular preferred that the groups R¹⁰ and R¹¹ are position meta- or para-position.

In a particular preferred embodiment, the at least one aromatic dicarboxylic acid is selected from terephthalic acid and isophthalic acid.

In a further preferred embodiment of the invention, the at least one repeating unit derived from at least one aromatic dicarboxylic acid is derived from terephthalic acid, optionally in combination with at least one further aromatic dicarboxylic acid, in particular in combination with isophthalic acid. Preferably, the at least one repeating unit derived terephthalic acid is comprised in combination with at least one repeating unit derived from at least one aliphatic dicarboxylic acid, in particular adipic acid, and optionally further in combination with at least at least one repeating unit derived from at least one further aromatic dicarboxylic acid, in particular isophthalic acid.

In a further preferred embodiment, the semi-aromatic polyamide comprises repeating units derived from aromatic dicarboxylic acids, in particular derived from terephthalic acid and optionally derived from at least on further dicarboxylic acid, preferably isophthalic acid, in amounts of from 10 mol-% to 100 mol-%, based on the total amount of repeating units derived from dicarboxylic acids, and more preferably from 20 mol-% to 60 mol-% of repeating units derived from dicarboxylic acids, whereas the remainder of the of repeating units derived from dicarboxylic acids is derived from aliphatic dicarboxylic acids.

In this embodiment, the total amount of repeating units derived from terephthalic acid is preferably from 10 mol-% to 100 mol-%, based on the total amount of repeating units derived from aromatic dicarboxylic acids, more preferably 10 mol-% to 60 mol-%, and in particular from 20 mol-% to 50 mol-%, based on the total amount of repeating units derived from aromatic dicarboxylic acids; and

the total amount of repeating units derived from at least one optional further aromatic dicarboxylic acid, in particular isophthalic is preferably from 0 mol-% to 90 mol-%, based on the total amount of repeating units derived from aromatic dicarboxylic acids, more preferably 40 mol-% to 90 mol-%, and in particular from 50 mol-% to 80 mol-%, based on the total amount of repeating units derived from aromatic dicarboxylic acids.

In one particular preferred embodiment of the invention, the semi-aromatic polyamide comprises repeating units derived from

(a) terephthalic acid in an amount of from 10 to 60 mol-%, based on the total amount of repeating units derived from dicarboxylic acids, and

(b) adipic acid in an amount of from 40 to 90 mol-%, based on the total amount of repeating units derived from dicarboxylic acids;

wherein the total amount of terephthalic acid and adipic acid amounts up to 100 mol-% of the amount of repeating units derived from dicarboxylic acids.

In an alternative particular preferred embodiment of the invention, the semi-aromatic polyamide comprises repeating units derived from

(a) terephthalic acid in an amount of from 10 to 60 mol-%, based on the total amount of repeating units derived from dicarboxylic acids, and

(b) isophthalic acid in an amount of from 40 to 90 mol-%, based on the total amount of repeating units derived from dicarboxylic acid;

wherein the total amount of terephthalic acid and isophthalic acid amounts up to 100 mol-% of the amount of repeating units derived from dicarboxylic acids.

In a further alternative particular preferred embodiment of the invention, the semi-aromatic polyamide comprises repeating units derived from

(a) terephthalic acid and at least one further aromatic dicarboxylic acid in an amount of from 10 to 60 mol-%, based on the total amount of repeating units derived from dicarboxylic acids, and

(b) adipic acid in an amount of from 40 to 90 mol-%, based on the total amount of repeating units derived from dicarboxylic acids;

wherein the total amount of adipic acid, terephthalic acid and the at least one further aromatic dicarboxylic acid amounts up to 100 mol-% of the amount of repeating units derived from dicarboxylic acids, and

wherein the terephthalic acid accounts for 10 to 60 mol-%, based on the total amount of repeating units derived from aromatic dicarboxylic acids, and the at least one further aromatic acid, in particular isophthalic acid, accounts for 40 to 90 mol-%, based on the total amount of repeating units derived from aromatic dicarboxylic acids.

Thus, in one preferred embodiment of the invention, the polyamide composition comprises at least one semi-aromatic polyamide selected from homopolymers and/or copolymers of hexamethylenediamine, adipic acid and terephthalic acid and/or isophthalic acid.

In one particular preferred embodiment of the invention, the at least one semi-aromatic polyamide is selected from copolymers of hexamethylenediamine, adipic acid and terephthalic acid (PA6.6/6.T), copolymers of hexamethylenediamine, adipic acid and isophthalic acid (PA6.6/6.1), copolymers of hexamethylenediamine, adipic acid, terephthalic acid and isophthalic acid (PA6.6/6.T/6.1) and mixtures of these semi-aromatic polyamides.

Preferably, the at least one semi-aromatic polyamide has a number average molecular weight (Mn), determined by gel permeation chromatography (GPC) of 10,000 g/mol to 28,000 g/mol, in particular 12,000 g/mol to 22,000 g/mol.

The at least one aromatic polyamide is present in the polyamide composition in amounts of 4 to 30 wt.-%, preferably 5 to 25 wt.-%, based on the total weight of the polyamide composition.

The polyamide composition of the invention further comprises at least one fibrous filler and at least one particulate filler. Preferably, the at least one fibrous filler is characterized in being substantially composed of fibrous particles having an aspect ratio of length to diameter (L/D) of more than 20 and the particulate filler is characterized in being substantially composed of particulate particles having an aspect ratio L/D of less than 20.

The at least one fibrous filler is preferably selected from glass fibres, ceramic fibres, carbon fibres, and thermostable polymer fibres. Preferably, said fibrous filler is fibre glass. The glass fibres preferably used have a length between 1 mm and 5 mm and a diameter of between 5 μm and 20 μm, prior to the preparation of the polyamide composition by mixing the components (i) to (vi). During the mixing and kneading with molten polymer, the fibres break and have an average length in the polyamide composition between 300 and 500 μm.

Advantageously, the fibrous filler may comprise particles having a size which improves certain properties of the composition. Moreover, it can include a sizing resistant glycolysis, especially when the article or the workpiece is intended to be in contact with a liquid containing alcohol such as cooling fluids or fuels.

The at least one particulate filler is selected from mineral fillers, glass beads, glass flakes, milled glass fibres. In a preferred embodiment of the invention, the particulate filler is preferably of glass beads, preferably glass beads having a diameter between 10 μm and 60 μm, or milled glass fibres of length less than 250 μm and a diameter less than 20 μm. Particular preferred are glass beads.

Thus, in one particular preferred embodiment of the invention, the polyamide composition comprises at least one fibrous filler selected from glass fibres and the at least particulate filler selected from glass beads.

The total amount of fibrous and particulate fillers in the composition may vary within wide limits and is, for example, between 10 wt.-% and 60 wt.-%, preferably 20 wt.-% and 45 wt.-%, based on the total weight of the composition. The weight ratio of the particulate filler and the fibrous filler is preferably between 0.2 and 10, preferably between 0.5 and 4.

The at least one fibrous filler is present in the polyamide composition in amounts of 9 to 40 wt.-%, preferably 15 to 30 wt.-%, based on the total weight of the polyamide composition.

The at least one particulate filler is present in the polyamide composition in amounts of 1 to 20 wt.-%, preferably 5 to 15 wt.-%, based on the total weight of the polyamide composition.

The polyamide composition further comprises at least one heat stabilizer. The heat stabilizer may be selected from copper salts, iron salts, phosphate stabilizers, aromatic amines and/or phenolic antioxidants.

The at least one heat stabilizer is preferably present in an amount of 0.1 to 2 wt.-%, based on the total weight of the polyamide composition, in particular 0.1 to 1 wt.-%.

The polyamide composition further comprises at least one further additive including all additives commonly used in polyamide compositions. Preferably, the at least one additive is selected from colorants, mould release agents, flame retardants, toughening modifiers, and additives to facilitate the mixing of the components or the moulding of the composition. Particular preferred embodiments comprise colorants, such as dyes and pigments, and/or mould release agents as additives.

The at least one additive is preferably present in an amount of 0.1 to 2 wt.-%, based on the total weight of the polyamide composition, in particular 0.1 to 1 wt.-%.

Furthermore, the polyamide composition according to the invention may optionally comprise:

(vii) at least one polyamide selected from homopolymers of ϵ-caprolactam (PA6), copolymers of ϵ-caprolactam with hexamethylenediamine and terephthalic acid and copolymers of ϵ-caprolactam with hexamethylenediamine and isophthalic acid; and/or

(viii) at least one polyamide selected from homopolymers of hexamethylenediamine and sebacic acid (PA6.10).

The homopolymers of ϵ-caprolactam (PA6), copolymers of ϵ-caprolactam with hexamethylenediamine and terephthalic acid, copolymers of ϵ-caprolactam with hexamethylenediamine and isophthalic acid and homopolymers of hexamethylenediamine and sebacic acid (PA6.10) are able to further improve the surface properties, in particular the surface gloss, of polyamide composition and the articles prepared therefrom. PA6 may be added in accordance to improve the flowability of the polyamide composition. Copolymers of ϵ-caprolactam with hexamethylenediamine and terephthalic acid or isophthalic acid are able to improve the balance between flowability, heat resistance, water absorption and dimension stability. PA6.10 is able to further enhance glycol resistance performance.

The at least one polyamide selected from homopolymers of ϵ-caprolactam (PA6), copolymers of ϵ-caprolactam with hexamethylenediamine and terephthalic acid and copolymers of ϵ-caprolactam with hexamethylenediamine and isophthalic acid preferably has a number average molecular weight (Mn), determined by gel permeation chromatography (GPC) of 10,000 g/mol to 28,000 g/mol, in particular 12,000 g/mol to 22,000 g/mol, and is preferably present in amounts of from 0 to 20 wt.-%, based on the total weight of the polyamide composition, preferably 1 to 15 wt.-%, and in particular 2 to 10 wt.-%.

The at least one polyamide selected from homopolymers of hexamethylenediamine and sebacic acid (PA6.10) has preferably a number average molecular weight (Mn), determined by gel permeation chromatography (GPC) of 10,000 g/mol to 28,000 g/mol, in particular 12,000 g/mol to 22,000 g/mol, and is preferably present in amounts of from 0 to 20 wt.-%, based on the total weight of the polyamide composition, preferably 1 to 15 wt.-%, and in particular 2 to 10 wt.-%.

Thus, in one embodiment of the invention, the present invention relates to a polyamide composition, comprising

(i) 40 to 70 wt.-%, based on the total weight of the polyamide composition, of at least one aliphatic polyamide comprising repeating units derived from the polycondensation of hexamethylenediamine and adipic acid;

(ii) 4 to 30 wt.-%, based on the total weight of the polyamide composition, of at least one semi-aromatic polyamide comprising repeating units derived from the polycondensation of hexamethylenediamine, adipic acid and at least one aromatic dicarboxylic acid;

(iii) 10 to 40 wt.-%, based on the total weight of the polyamide composition, of at least one fibrous filler;

(iv) 1 to 20 wt.-%, based on the total weight of the polyamide composition, of at least one particulate filler;

(v) 0.1 to 2 wt.-%, based on the total weight of the polyamide composition, of at least one heat stabilizer;

(vi) 0.1 to 2 wt.-%, based on the total weight of the polyamide composition, of at least one further additive;

(vii) 0 to 20 wt.-%, based on the total weight of the polyamide composition, of at least one polyamide selected from homopolymers of ϵ-caprolactam (PA6), copolymers of ϵ-caprolactam with hexamethylenediamine and terephthalic acid and copolymers of ϵ-caprolactam with hexamethylenediamine and isophthalic acid; and

(viii) 0 to 20 wt.-%, based on the total weight of the polyamide composition, of at least one polyamide selected from homopolymers of hexamethylenediamine and sebacic acid (PA6.10),

wherein the components (i) to (viii) and preferred embodiments thereof are as defined above.

The polyamide compositions of the invention are generally prepared by mixing in a twin-screw extruder or single-screw polyamide and different loads.

The polyamide composition is extruded as rods which are cut to form granules

The polyamide composition preferably has a flexural strength after aging at 130° C. for 1000 hours in a glycol/water mixture (1:1) of >15 MPa, in particular of >25 MPa (determined as described in the experimental section).

The polyamide composition preferably has a flexural strength at 23° C. (according to ISO 178) of >160 MPa, more preferably >180 MPa, and in particular >200 MPa (determined as described in the experimental section).

The polyamide composition preferably has a tensile strength DAM at 23° C. (according to ISO 527-2/1A) of >125 MPa, in particular >135 MPa (determined as described in the experimental section).

The polyamide composition preferably has a Charpy unnotched impact strength at 23° C. (according to ISO 179/1eU) of >30 kJ/m², more preferred >35 kJ/m², and in particular >40 kJ/m² (determined as described in the experimental section).

The polyamide composition preferably has a Charpy notched impact strength at 23° C. (according to ISO 179/1eA) of >5 kJ/m², in particular >6 kJ/m² (determined as described in the experimental section).

The polyamide composition preferably has a heat deformation temperature at 1.82 mPa (according to ISO 75/Af) of >200° C., in particular >210° C. (determined as described in the experimental section).

The polyamide compositions of the invention may preferably be used for the preparation of an article in a liquid-assisted injection moulding process, in particular water-assisted injection moulding process. Liquid-assisted moulding processes of thermoplastic polymer compositions are known in the art and for example described in EP 1136221 A1 and in Kunststoffe, vol. 88, no. 1, 1998, pages 34-36.

A further object of the invention is concerned with a process for preparing an article, comprising at least the following process steps:

(a) providing a polyamide composition as defined above;

(b) preparing a substantially liquid melt of the polyamide composition; and

(c) conducting a liquid-assisted injection moulding process in order to obtain the article.

According to step (a) of the process, the polyamide composition as previously defined is provided, for example in form of its pellets. However, steps (a) and (b) may also be combined in one step, thus providing the components (i) to (viii) and combining them while melting the composition at the same time.

The polyamide composition is then liquefied, preferably by introducing to an optionally heatable mixing apparatus and blended therein, producing a substantially liquid-melt polymer mixture.

“Substantially liquid melt” means that the polymer mixture, as well as the predominant liquid-melt (softened) fraction, may further comprise a certain fraction of solid components, examples being unmelted fillers and reinforcing material such as glass fibers, glass beads or unmelted pigments, colorants, etc. “ Liquid melt” means that the polymer mixture is at least of low fluidity, therefore having softened at least to an extent that it has plastic properties.

Mixing apparatuses used are those known to the skilled person. Components (i) to (vi), and—where included—(vii) and/or (viii) may be mixed, for example, by joint extrusion, kneading, or rolling. Examples of mixing apparatus for implementing the method include discontinuously operating, heated internal kneading devices, continuously operating kneaders, such as continuous internal kneaders, screw kneaders with axially oscillating screws, Banbury kneaders, furthermore extruders, and also roll mills, mixing roll mills with heated rollers, and calenders.

A preferred mixing apparatus used is an extruder or a kneader. Particularly suitable for melt extrusion are, for example, single-screw or twin-screw extruders. A twin-screw extruder is preferred.

In some cases the mechanical energy introduced by the mixing apparatus in the course of mixing is enough to cause the mixture to melt, meaning that the mixing apparatus does not have to be heated. Otherwise, the mixing apparatus is generally heated.

The temperature is guided by the chemical and physical properties of the polyamide composition and should be selected such as to result in a substantially liquid-melt polymer mixture. On the other hand, the temperature is not to be unnecessarily high, in order to prevent thermal damage of the polymer mixture. The mechanical energy introduced may, however, also be high enough that the mixing apparatus may even require cooling. Mixing apparatus is operated customarily at 150° C. to 400° C., preferably 200° C. to 350° C.

The substantially liquid melt is then introduced in the desired mould. In order to form hollow articles, a liquid, in particular water is introduced to the mould comprising the substantially liquid melt of the polyamide composition, in order to form at least one cavity in the article. After cooling below the melting point of the polyamide composition, the article may be released from the mould.

The method enables the manufacture of hollow articles having a uniform wall thickness and preferably of thickness less than 10 mm. These articles are especially elongate hollow body such as ducts, pipes, tubes or the like.

The surfaces of the articles, in particular the inner surfaces of the hollow articles, are particularly smooth compared to articles prepared from conventional fibre filled polyamide compositions. In particular, the inner surface of the hollow body is sufficiently smooth to permit fluid flow in the hollow body without disturbance.

Thus, the method of the invention allows the manufacture of conduits, pipes for fuel, coolant or air to the internal combustion engine or combustion.

Moreover, the articles are characterized by their good resistance against alcohols and alcoholic solutions, in particular against glycols and glycol solution (e.g. aqueous glycol solutions as used in antifreeze fluids and brake fluids). Accordingly, the polyamide composition of the invention is preferably used for the preparation of hollow articles to be used in automotive industry, in particular in engine oil tubes, brake hoses, conduits, pipes for fuel and/or coolant.

Thus, one further object of the present invention is an article comprising at least the polyamide composition of the invention. In particular, the invention is concerned with an article obtained by the process described above, in particular a hollow article.

Other advantages and details of the invention will become apparent from the examples given below for illustrative purposes only.

### EXAMPLES

Preparation of the polyamide compositions:

As examples and comparative examples, several polyamide compositions were prepared.

The following components were used as starting materials:

Component (i):
(i-a) PA6.6 homopolymer
(i-b) PA6.6/6 copolymer having a molar composition of repeating units derived from hexamethylene diamine:adipic acid:ϵ-caprolactam of 45.0%:45.0%:10.0%(in mol-% each)

Component (ii):

(ii-a) PA6.6/6.T copolymer having a molar composition of repeating units derived from hexamethylene diamine:terephthalic acid:adipic acid of 50.0%:32.5%:17.5% (in mol-% each)

(ii-b) PA6.T/6.I copolymer having a molar composition of repeating units derived from hexamethylene diamine:terephthalic acid:isophthalic acid of 50.0%:35.0%:15.0% (in mol-% each)

Component (iii):
(iii) glass fibre chopped strands having an average length of 4.5 mm and an average diameter of 10 μm

Component (iv):
(iv-a) glass beads having an average diameter of 20 μm
(iv-b) glass beads having an average diameter of 40 μm
(iv-c) glass beads having an average diameter of 5 μm
(iv-d) glass beads having an average diameter of 100 μm

Component (v):
(v) copper salts as heat stabilizer

Component (vi):
(vi-a) ethylene bis-stearamide as mould release agent
(vi-b) colorants (solvent black/nigrosine)
(vi-c) modified ethylene bis-stearamide (TAF, surface improvement agent)

Component (vii)
(vii) PA6 homopolymer

Component (viii):
(viii) PA6.10 homopolymer

Component (ix):
(ix) PA6/6T copolymer

Compositions for moulding according to the invention were prepared by mixing in a twin-screw type extruder ZSK 18 W at a rate of 12 kg/h and a rotation speed of equal screw 300 rev/min, at a temperature in the range of from 265° C. to 340° C., depending on the formulation of the various components and amounts as disclosed in Table 1 below.

TABLE 1
Composition of Comparative Examples C1 to C5 and Examples E1 to E9 according to the invention.

| | Examples | | | | | | | | | |
|---|---|---|---|---|---|---|---|---|---|---|
| Components | C1 | C2 | E1 | C3 | E2 | E3 | C4 | E4 | C5 | E5 |
| (i-a) | 67 | 57 | 61 | 63 | 47 | 46.7 | 27 | 11 | 67 | 51 |
| (i-b) | — | — | — | — | — | — | 40 | 40 | — | — |
| (ii-a) | — | — | 6 | — | 16 | 16 | — | 16 | — | 16 |
| (ii-b) | — | — | — | — | — | — | — | — | — | — |
| (iii) | 20 | 20 | 20 | 20 | 20 | 20 | 20 | 20 | 23 | 23 |
| (iv-a) | 10 | 10 | 10 | 10 | 10 | 10 | 10 | 10 | 7 | 7 |
| (iv-b) | — | — | — | — | — | — | — | — | — | — |
| (iv-c) | | | | | | | | | | |
| (iv-d) | | | | | | | | | | |
| (v) | 0.83 | 0.83 | 0.83 | 0.83 | 0.83 | 0.83 | 0.83 | 0.83 | 0.83 | 0.83 |
| (vi-a) | 0.17 | 0.17 | 0.17 | 0.17 | 0.17 | 0.17 | 0.17 | 0.17 | 0.17 | 0.17 |
| (vi-b) | 2 | 2 | 2 | 2 | 2 | 2 | 2 | 2 | 2 | 2 |
| (vi-c) | — | — | — | — | — | 0.3 | — | — | — | — |
| (vii) | — | 10 | — | 4 | 4 | 4 | — | — | — | — |
| (viii) | — | — | — | — | — | — | — | — | — | — |
| (ix) | | | | | | | | | | |
| Components | E6 | E7 | E8 | E9 | C6 | C7 | E10 | E11 | E12 | E13 |
| (i-a) | 47 | 47 | 47 | 47 | 0 | 47 | 16 | 47 | 47 | [symbol] |
| (i-b) | — | — | — | — | — | — | — | — | — | [symbol] |
| (ii-a) | 16 | 16 | 16 | — | 16 | — | 47 | 16 | 16 | 16 |
| (ii-b) | — | — | 20 | — | — | — | — | — | — | — |
| (iii) | 23 | 23 | 23 | 23 | 23 | 23 | 23 | 7 | 23 | 23 |
| (iv-a) | 7 | — | 7 | 7 | 7 | 7 | 7 | 23 | — | — |
| (iv-b) | — | 7 | — | — | — | — | — | — | — | — |
| (iv-c) | | | | | | | | | 7 | — |
| (iv-d) | | | | | | | | | — | 7 |
| (v) | 0.83 | 0.83 | 0.83 | 0.83 | 0.83 | 0.83 | 0.83 | 0.83 | 0.83 | 0.83 |
| (vi-a) | 0.17 | 0.17 | 0.17 | 0.17 | 0.17 | 0.17 | 0.17 | 0.17 | 0.17 | 0.17 |
| (vi-b) | 2 | 2 | 2 | 2 | 2 | 2 | 2 | 2 | 2 | 2 |
| (vi-c) | — | — | — | — | — | — | — | — | — | |
| (vii) | 4 | 4 | — | — | 51 | 4 | 4 | 4 | 4 | 4 |
| (viii) | — | — | 4 | — | — | — | — | — | — | — |
| (ix) | | | | | — | 16 | — | — | — | — |

[symbol]

indicates data missing or illegible when filed

[symbol]

Samples were prepared from each of these compositions C1 to C5 and E1 to E9 in accordance with the demands described below.

The following properties were determined:

Tensile Strength:

Tensile strength was determined according to ISO 527-2/1A. Values are given in MPa

Flexural strength:

Determination of flexural strength at maximum load was carried out according to ISO 178 with test samples having a size of 50×6 mm and a thickness of 4 mm. Support separation: 40 mm. Test rate was 14 mm/min. Values are given in MPa.

Charpy unnotched impact strength:

Charpy unnotched impact strength was determined according to ISO 179/1eU with test samples having a size of 50×6 mm and a thickness of 4 mm. Support separation: 40 mm. Test equipment: 4 J pendulum impact tester. Values are given in kJ/m².

Charpy notched impact strength:

Charpy notched impact strength was determined according to ISO 179/1eA with test samples having a size of 50×6 mm and a thickness of 4 mm. Support separation: 40 mm. Test equipment: 4 J pendulum impact tester. A 0.8 mm-wide U-shaped notch was made on the broad side of the specimens. The notch depth was ⅓ of the specimen thickness. The edges outlining the notch root had a curvation radius of <0.1 mm. Values are given in kJ/m².

Heat deformation temperature:

Heat deformation temperature was determined at 1.82 MPa according to ISO 75/Af. Values are given in ° C.

Flexural strength after aging

Flexural strength after aging was determined after aging the specimen (prepared by injection molding according to DIN EN ISO 527-2/1A) in a glycol/water mixture (1:1 by weight) at 130° C. for 1000 hours. Following the aging process, flexural strength was determined according to DIN EN ISO 178 at room temperature with the undried specimen after 1 hour. Values are given in MPa.

Gloss with flat chip:

Surface gloss was tested using a Benchtop Spectrophotometer (model Ci7800 manufactured by X-rite®, Inc.). The testing was made in gloss test. The specimens were flat chips having dimensions of 9×6×2 mm.

Spiral flow:

The polyamide composition is melted and then injected into a spiral shaped moulding cavity mounted on an injection-moulding machine under real processing conditions. The spiral length with 2 mm thickness can be determined as a function of melt temperature, injection pressure and the mould temperature and is a direct measure for the flowability (i.e. viscosity) of the polyamide composition.

Results of the tests:

The results of the tests for all Examples and Comparative Examples are summarized in Table 2.

As shown in Table 1, Comparative Example C1 is a PA6.6 based composition filled with glass fibres and glass beads. C1 exhibits a gloss with flat chip of 76.8.

In Comparative Example C2, 10 wt.-% of the PA6.6 are substituted by PA6, a well-known additive to improve the surface of glass fibre filled PA66 compositions (cf. Table 1). The gloss is improved from 76.8 to 90.3 (cf. Table 2).

However, according to inventive Example E1, substituting 6 wt.-% of PA6.6 by PA6.6/6.T results in an improvement of surface gloss with flat chip to 91.6 (cf. Tables 1 and 2). Thus, although E1 comprises only 6 wt.-% of PA6.6/6.T compared to 10 wt.-% of PA6 used in Comparative Example C2, a higher surface gloss was achieved (91.6 for Example E1 compared to 90.3 for Comparative Example C2). PA6.6/6.T thus results in significantly higher surface improvement compared to PA6.

Moreover, flexural strength of the PA6 containing sample according to Comparative Example C2 was significantly deteriorated after aging in glycol/water. Comparative Example E1 exhibits a value for 70 MPa, which decreases to 46 MPa for Comparative Example 2 comprising PA6. By contrast, introducing PA6.6/6.T resulted in only far lower decrease of flexural strength after aging from 70 MPa (Comparative Example C1) to 63 MPa (Example E1).

In addition also the further determined mechanical properties such as tensile strength, flexural strength, Charpy unnotched impact strength, Charpy notched impact strength, heat deformation temperature, and spiral flow remain substantially unchanged in Example E1 compared to Comparative Example C1.

TABLE 2
Properties of the Comparative Examples C1 to C5 and inventive Examples E1 to E9.

| | Examples | | | | | | | | | |
|---|---|---|---|---|---|---|---|---|---|---|
| Properties | C1 | C2 | E1 | C3 | E2 | E3 | C4 | E4 | C5 | E5 |
| Tensile | 141 | 138 | 140 | 141 | 144 | 144 | 140 | 138 | 148 | 158 |
| Strength | | | | | | | | | | |
| [MPa] | | | | | | | | | | |
| Flexural | 210 | 205 | 207 | 209 | 205 | 205 | 209 | 202 | 220 | 231 |
| strength | | | | | | | | | | |
| [MPa] | | | | | | | | | | |
| Charpy | 48 | 54 | 46 | 51 | 45 | 46 | 51 | 43 | 50 | 54.9 |
| unnochted | | | | | | | | | | |
| impact | | | | | | | | | | |
| strength | | | | | | | | | | |
| [kJ/m²] | | | | | | | | | | |
| Charpy | 6.3 | 6.6 | 6.3 | 6.5 | 6.2 | 6.4 | 6.8 | 6.2 | 7.5 | 8 |
| notched | | | | | | | | | | |
| impact | | | | | | | | | | |
| strength | | | | | | | | | | |
| [kJ/m²] | | | | | | | | | | |
| Heat | 236 | 229 | 234 | 230 | 227 | 226 | 217 | 215 | 238 | 233 |
| deformation | | | | | | | | | | |
| temperature | | | | | | | | | | |
| at 1.82 mPa | | | | | | | | | | |
| Flexural | 70 | 46 | 63 | 58 | 43 | 43 | 28 | 16 | 73 | 73.9 |
| strength | | | | | | | | | | |
| after aging | | | | | | | | | | |
| [MPa] | | | | | | | | | | |
| Gloss with | 76.8 | 90.3 | 91.6 | 70.4 | 96 | 91 | 94 | 96.6 | 77.7 | 93.6 |
| flat chip | | | | | | | | | | |
| Spiral flow | 58.8 | 53.6 | 57.1 | 49.5 | 57.3 | 60.2 | 58.5 | 60.9 | 59 | 59.5 |
| [mm] | | | | | | | | | | |
| Properties | E6 | E7 | E8 | E9 | C6 | C7 | E10 | E11 | E12 | [symbol] |
| Tensile | 158 | 150 | 158 | 152 | 160 | 162 | 156 | 96 | 173 | [symbol] |
| Strength | | | | | | | | | | |
| [MPa] | | | | | | | | | | |
| Flexural | 226 | 223 | 229 | 214 | 236 | 244 | 240 | 158 | 252 | [symbol] |
| strength | | | | | | | | | | |
| [MPa] | | | | | | | | | | |
| Charpy | 53.6 | 44.9 | 50 | 35.7 | 57 | 59 | 46 | 31 | 64 | 57 |
| unnochted | | | | | | | | | | |
| impact | | | | | | | | | | |
| strength | | | | | | | | | | |
| [kJ/m²] | | | | | | | | | | |
| Charpy | 7.6 | 7.5 | 7.9 | 7.1 | 8.51 | 8.43 | 8.53 | 3.71 | 9.32 | 9.21 |
| notched | | | | | | | | | | |
| impact | | | | | | | | | | |
| strength | | | | | | | | | | |
| [kJ/m²] | | | | | | | | | | |
| Heat | 232 | 230 | 232 | 232 | 197 | 221 | 238 | 189 | 235 | 235 |
| deformation | | | | | | | | | | |
| temperature | | | | | | | | | | |
| at 1.82 mPa | | | | | | | | | | |
| Flexural | 59 | 54 | 67.7 | 65.2 | 29 | 41.7 | 55 | 26.3 | 56.4 | 56 |
| strength | | | | | | | | | | |
| after aging | | | | | | | | | | |
| [MPa] | | | | | | | | | | |
| Gloss with | 98.4 | 96.45 | 96.9 | 91.2 | 99 | 98.3 | 99.1 | 98.7 | 97.2 | [symbol] |
| flat chip | | | | | | | | | | |
| Spiral flow | 59.4 | 62.6 | 60.1 | 36.9 | 65.8 | 59.7 | 62 | 64.3 | 59.3 | [symbol] |
| [mm] | | | | | | | | | | |

[symbol]

indicates data missing or illegible when filed

[symbol]

The comparison of Comparative Example C3 and Examples E2 and E3 reveals that also the properties of blends of PA6.6 and PA6 comprising glass fibres may further be improved by the addition of PA6.6/6.T (cf. Tables 1 and 2). Just like Comparative Example C1, all three Examples C3, E2 and E3 comprise a sum of about 67 wt.-% of polyamide. However, in each of the three examples C3, E2 and E3, 4 wt.-% of the PA6.6 is replaced by PA6. Additionally in

Examples E2 and E3, further 16 wt.-% of the PA6.6 is replaced by 16 wt.-% of PA6.6/6.T (Example E2, cf. Table 1) or by 15.7 wt.-% of PA6.6/6.T and 0.3 wt.-% of TAF, a modified ethylene bis-stearamide which is reported to improve the surface of glass fibre filled polymer compositions (Example E3, cf. Table 1).

As can be seen in Table 2, substituting 16 wt.-% of the PA6.6 of the polyamide composition according to Comparative Example C3 results in an improvement of the surface gloss from 70.4 to 96 in Example E2. The incorporation of TAF, however, failed to further improve surface gloss. In contrast, Example E3 resulted in a lower gloss than E2 (96 for Example E2 compared to 91 for Example E3, cf. Table 2). However, both Examples E2 and E3 have a substantially higher surface gloss than Comparative Example C3.

In addition also the further determined mechanical properties such as tensile strength, flexural strength, Charpy unnotched impact strength, Charpy notched impact strength, heat deformation temperature, and spiral flow remain substantially unchanged in Examples E2 and E3 compared to Comparative Example C2. Flexural strength of Examples E2 and E3 remains above 43.

Comparative Example C4 and Example E4 demonstrate the effect of the invention in polyamide compositions comprising PA6.6 and PA6.6/6. Again, both example compositions comprise 67 wt.-% of polyamides. In particular, both comprise 40 wt.-% of PA6.6/. Comparative Example C4 further comprises 27 wt.-% of PA6.6, whereas Example E4 comprises 11 wt.-% of PA6.6 and 16 wt.-% of PA6.6/6.T (cf. Table 1. The remainder is identical in both compositions.

As can be seen in Table 2, surface gloss is improved from 94 for Comparative Example C4 to 96.6 for Example E4. In addition, also the further determined mechanical properties such as tensile strength, flexural strength, Charpy unnotched impact strength, Charpy notched impact strength, and heat deformation temperature remain substantially unchanged in Example E4 compared to Comparative Example C4. Moreover, spiral flow is improved.

Compared to the previous discussed examples and comparative examples, Comparative Example C5 and Examples E5 to E9 comprise a higher amount of glass fibre filler (23 wt.-% instead of 20 wt.-%), whereas the overall amount of filler remains unchanged at 30 wt.-% (cf. Table 1).

Comparative Example C5 comprises PA6.6 as only polyamide and exhibits a surface gloss of 77.7. By replacing 16 wt.-% of the PA6.6 by PA6.6/6.T (cf. Example E5 in Table 1), in improvement of gloss from 77.7 to 93.6 is observed (cf. Comparative Example E5 and Example E5 Table 2).

In Example E6, further 4 wt.-% of PA6.6 were substituted by PA6 compared to Example E5 (cf. Table 1) while maintaining the total amount of polyamide unchanged. This results in a further improvement of the surface gloss from 93.6 for Example E5 (or 77.7 for Comparative Example C5, respectively) to 98.4 for Example E6 (cf. Table 2). Example 7 differs from Example 6 in comprising glass beads with an average particle diameter of 40 μm instead of 20 μm. Comparable results are obtained.

In Example E8, further 4 wt.-% of PA6.6 were substituted by PA6.10 compared to Example E5 (cf. Table 1) while maintaining the total amount of polyamide unchanged. This also results in an improvement of the surface gloss from 93.6 for Example E5 (or 77.7 for Comparative Example C5, respectively) to 96.9 for Example E8 (cf. Table 2).

In Example E9, further 20 wt.-% of PA6.6 were substituted by PA6.T/6.I compared to Comparative Example C5 (cf. Table 1) while maintaining the total amount of polyamide unchanged. This results in a further improvement of the surface gloss from 77.7 for Comparative Example C5 to 91.2 for Example E9 (cf. Table 2).

In addition, also further mechanical properties are improved. For example, tensile strength before aging is improved for all Examples E5 to E9 compared to Comparative Example C5. On the other hand, the tensile strength after aging in glycol/water mixture is only slightly deteriorated for Examples E5 to E9 and in particular Examples E5, E8 and E9 compared to Comparative Example C5. Likewise, good results or even improvements in properties such as flexural strength, Charpy unnotched impact strength, Charpy notched impact strength, heat deformation temperature, and spiral flow were observed and often remained substantially unchanged in Examples E5 and E9 compared to Comparative Example C5.

Comparative Example C6 demonstrates the advantageous effects of the presence of PA6.6 or a copolymer thereof in the composition. Since major application of the compositions of the invention are coolant tubes, excellent coolant resistance is needed. If PA6.6 is replaced with PA6, a significant decline in the glycol resistance is observed. Moreover, the heat deformation temperature decreases.

Comparative Example C7 demonstrates the advantageous effects of the presence of PA6.6/6.T as compared to PA6/6.T in the composition. If PA6.6/6T is replaced with PA6/6T, a significant decline in glycol resistance is observed. Moreover, the heat deformation temperature decreases.

Example E10 demonstrates the advantageous effects due to the amount (ratio) of PA6.6 and PA6.6/6.T in the composition. The ratio of PA6.6 to PA 6.6/6T affects the Charpy unnotched impact and glycol resistance.

Example E11 demonstrates the relevance of the amount (ratio) of fibrous and particulate filler for the observed technical effect. The ratio affects the mechanical properties, the heat deformation temperature and the glycol resistance.

Examples E12 and E13 demonstrate the influence of particle fillers having particle diameters of more than 60 μm and less than 20 μm, respectively.

Conclusion:

The above examples and comparative examples show that the surface properties, in particular surface gloss of an article prepared from a polyamide composition comprising at least one aliphatic polyamide, at least one semi-aromatic polyamide, at least one fibrous filler, at least one particulate filler, at least one heat stabilizer, and at least one further additive as defined above, is significantly improved compared to polyamide compositions which do not comprise the at least one semi-aromatic polyamide. At the same time, further mechanical properties typically remain substantially unchanged. In particular, the polyamide composition in accordance with the present invention exhibits a good resistance towards alcohols, in particular glycols, as indicated by the comparably good flexural strength after aging was determined after aging the sample in a glycol/water mixture (1:1 by weight) at 130° C. for 1000 hours. The polyamide compositions are therefore exceptionally well suited to be used in the production of articles which are intended to be in contact with glycol and glycol mixtures, such as hollow articles to be used in the automotive industry.

1. A polyamide composition comprising:
(i) at least one aliphatic polyamide comprising repeating units derived from a polycondensation of hexamethylenediamine and adipic acid;
(ii) at least one semi-aromatic polyamide comprising repeating units derived from a polycondensation of hexamethylenediamine, adipic acid and at least one aromatic dicarboxylic acid;
(iii) at least one fibrous filler;
(iv) at least one particulate filler;
(v) at least one heat stabilizer;
(vi) at least one further additive;
(vii) optionally at least one polyamide selected from homopolymers of ϵ-caprolactam (PA6), copolymers of ϵ-caprolactam with hexamethylenediamine and terephthalic acid and copolymers of ϵ-caprolactam with hexamethylenediamine and isophthalic acid; and
(viii) optionally at least one polyamide selected from homopolymers of hexamethylenediamine and sebacic acid (PA6.10).

2. The polyamide composition according to claim 1, wherein the at least one semi-aromatic polyamide comprises repeating units derived from at least one aromatic dicarboxylic acid in an amount of at least 5 mol.-%, based on a total weight of the at least one semi-aromatic polyamide.

3. The polyamide composition according to claim 1, wherein the at least one semi-aromatic polyamide is selected from homopolymers and/or copolymers of hexamethylenediamine and adipic acid with terephthalic acid and/or isophthalic acid.

4. The polyamide composition according to claim 1, wherein the at least one semi-aromatic polyamide is selected from copolymers of hexamethylenediamine, adipic acid and terephthalic acid (PA6.6/6.T), copolymers of hexamethylenediamine, adipic acid and isophthalic acid (PA6.6/6.I), copolymers of hexamethylenediamine, adipic acid, terephthalic acid and isophthalic acid (PA6.6/6.T/6.I) and mixtures of these semi-aromatic polyamides.

5. The polyamide composition according to claim 1, wherein the at least one aliphatic polyamide is selected from homopolymers of hexamethylenediamine and adipic acid (PA6.6), copolymers of hexamethylenediamine, adipic acid and ϵ-caprolactam (PA6.6/6) and mixtures of these aliphatic polyamides.

6. The polyamide composition according to claim 1, wherein the at least one fibrous filler is selected from glass fibres, ceramic fibres, carbon fibres, and thermostable polymer fibres.

7. The polyamide composition according to claim 1, wherein the at least one particulate filler is selected from mineral fillers, glass beads, glass flakes, and milled glass fibres.

8. The polyamide composition according to claim 1, wherein the at least one fibrous filler is selected from glass fibres and the at least particulate filler is selected from glass beads.

9. The polyamide composition according to claim 1, wherein the at least one additive is selected from colorants, mould release agents, flame retardants, toughening modifiers, and additives to facilitate the mixing of the components or the moulding of the composition.

10. The polyamide composition according to claim 1, further comprising:
(i) 40 to 70 wt.-%, based on a total weight of the polyamide composition, of the at least one aliphatic polyamide comprising repeating units derived from the polycondensation of hexamethylenediamine and adipic acid;
(ii) 4 to 30 wt.-%, based on the total weight of the polyamide composition, of the at least one semi-aromatic polyamide comprising repeating units derived from the polycondensation of hexamethylenediamine, adipic acid and at least one aromatic dicarboxylic acid;
(iii) 10 to 40 wt.-%, based on the total weight of the polyamide composition, of the at least one fibrous filler;
(iv) 1 to 20 wt.-%, based on the total weight of the polyamide composition, of the at least one particulate filler;
(v) 0.1 to 2 wt.-%, based on the total weight of the polyamide composition, of the at least one heat stabilizer;
(vi) 0.1 to 2 wt.-%, based on the total weight of the polyamide composition, of the at least one further additive;
(vii) 0 to 20 wt.-%, based on the total weight of the polyamide composition, of the at least one polyamide selected from homopolymers of ϵ-caprolactam (PA6), copolymers of ϵ-caprolactam with hexamethylenediamine and terephthalic acid and copolymers of ϵ-caprolactam with hexamethylenediamine and isophthalic acid; and
(viii) 0 to 20 wt.-%, based on the total weight of the polyamide composition, of the at least one polyamide selected from homopolymers of hexamethylenediamine and sebacic acid (PA6.10).

11. The polyamide composition according to claim 10, wherein the at least one aliphatic polyamide is selected from homopolymers of hexamethylenediamine and adipic acid (PA6.6) and copolymers of hexamethylenediamine, adipic acid and ϵ-caprolactam (PA6.6/6) and wherein only the repeating units derived from hexamethylenediamine and adipic acid account to an amount of 40 to 70 wt.-% of the at least one aliphatic polyamide based on the total weight of the polyamide composition.

12. (canceled)

13. A process for preparing an article, the process comprising at least the following process steps:
(a) providing a polyamide composition according to claim 1;
(b) preparing a substantially liquid melt of the polyamide composition; and
(c) conducting a liquid-assisted injection moulding process in order to obtain the article.

14. An article comprising at least the polyamide composition according to claim 1.

15. An article obtained by the process according to claim 13.
